(19) United States
(12) Patent Application Publication
(10) Pub. No.: US 2005/0053309 A1
(43) Pub. Date: Mar. 10, 2005

(54) Image processors and methods of image processing

(76) Inventors: Steven J. Szczuka, Chino Hills, CA (US); John E. Hoot, San Clemente, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/922,787

(22) Filed: Aug. 20, 2004

Related U.S. Application Data
(60) Provisional application No. 60/497,098, filed on Aug. 22, 2003.

(51) Int. Cl. G06K 9/00

(52) U.S. Cl. 382/284

(57) ABSTRACT

In various embodiments of the invention, optical imaging systems such as telescopes and binoculars utilize a method of image processing comprising receiving a set of images and evaluating the quality of the images by performing a quantitative evaluation of at least a portion of the image. A subset of said images are selected based on the quality of the images and the subset of images are combined into a composite image. These optical imaging systems preferably comprise imaging optics, an optical detector array, and a processor for processing the images.

### PRIORITY APPLICATIONS

This application claims priority to U.S. Provisional Application No. 60/497,098 entitled “Image Processors and Methods of Image Processing” filed Aug. 22, 2003, which is hereby incorporated herein by reference in its entirety.

### FIELD OF THE INVENTION

The present invention relates to image processing, and in particular, to image processors and methods of image processing that can be employed, for example, to reduce blur.

### BACKGROUND

Astronomical telescopes that enable optical imaging of celestial objects such as the moon, planets, and stars, can be outfitted with photographic cameras to record images of these heavenly objects on film. In such systems, the photographic film in the camera is disposed at a focal plane for the telescope.

Alternatively, optical images of the celestial objects can be recorded electronically by placing a CMOS detector array at the focal plane of the telescope. A CMOS detector array comprises a plurality of detectors that outputs an electrical signal in response to illumination. The outputs from the plurality of detectors (the detectors individually being referred to as pixels) together reconstruct the image. The electrical output may be transferred electronically to memory such as RAM or a storage device.

CMOS detector arrays, which are based on CMOS (Complementary Metal Oxide Semiconductor) technology, are generally less expensive than CCD focal plane arrays. CMOS detector arrays, however, are less sensitive than CCDs and accordingly are less suitable for low light level applications.

Images of celestial objects when obtained from earth commonly are blurred as a result of atmospheric effects such as fluctuations in the refraction index of the atmosphere, which changes with time, temperature, location, and altitude. These fluctuations in refractive index alter the propagation of light in an irregular and unpredictable manner and result in image degradation such as blurring.

What is needed, therefore, are apparatus and methods for reducing image degradation resulting from these atmospheric effects.

### SUMMARY OF THE INVENTION

One aspect of the invention comprises a method of image processing comprising receiving a set of images and evaluating the quality of the images by performing a quantitative evaluation of at least a portion of the image. A subset of the images is selected based on the quality of the images and the subset of images is combined into a composite image.

Another aspect of the invention comprises an optical imaging system comprising imaging optics having an image plane where an optical image is formed. The optical imaging system further comprises a detector array and an image processor. The detector array is substantially disposed in the image plane and outputs an electrical signal corresponding to an electronic image comprising a plurality of pixels. The image processor receives a plurality of the electronic images. The image processor is configured to evaluate the quality of the images, to select a subset of the electronic images based on the quality of the electronic images, and to combine the subset of electronic images into a composite image.

Another aspect of the invention comprises a computer program capable of accepting an input representing an optical image obtained from an optical imaging system. The computer program is configured to assess the quality of the image based on a measure of the amount of information in at least a portion of the image, to select images based on the amount of information measured, and to combine the selected images into a composite image.

Another aspect of the invention comprises an article of manufacture comprising an image processing module stored in a computer accessible storage media and executable in a processor. The image processing module is configured to measure compressibility of images, to select a subset of the images based on the compressibility, and to combine the subset of images into a composite image.

Another aspect of the invention comprises an optical system comprising means for receiving a set of images and means for evaluating the quality of the images by performing a quantitative evaluation of at least a portion of the image, selecting a subset of the images based on the quality of the images, and combining the subset of images into a composite image.

Various of the embodiments such as described above and elsewhere herein are applicable to telescopes and binoculars.

For example, another aspect of the invention comprises binoculars comprising left and right optical paths each comprising an objective and an ocular. The binoculars further comprise an electronic camera comprising an optoelectronic detector array outputting an electronic signal and image processing electronics for processing electronic images generated from the optoelectronic detector array. The imaging processing electronics are configured to combine a plurality of the electronic images into a composite image.

Another aspect of the invention comprises an optical imaging apparatus comprising binoculars, an electronic camera comprising an optoelectronic detector array outputting an electronic signal, and image processing electronics for processing the electronic images generated from optoelectronic detector array. The imaging processing electronics are configured to combine a plurality of the electronic images into a composite image.

Another aspect of the invention comprises an optical imaging apparatus comprising a telescope assembly including telescope optics, an electronic camera, and image processing electronics. The electronic camera is disposed with respect to the telescope assembly to receive light from the telescope optics for image formation and recording. The electronic camera comprises an optoelectronic detector array that outputs an electronic signal. The image processing electronics processes electronic images generated from optoelectronic detector array and are configured to combine a plurality of the electronic images into a composite image.

Another aspect of the invention comprises a telescope or binoculars comprising imaging optics having an adjustable focus. The telescope or binoculars further comprises a detector array that outputs an electrical signal corresponding to an electronic image comprising a plurality of pixels. The telescope or binoculars also comprises an image processor that receives a plurality of the electronic images obtained with different focus settings. The image processor is configured to evaluate the quality of these images corresponding to different focus settings. The telescope or binocular further comprises memory for recording which focus setting yield increased image quality.

### BRIEF DESCRIPTION OF THE DRAWINGS

FIGS. 1 and 2 are different views of a telescope having a CMOS camera attached thereto for recording images of distant objects.

FIG. 3 is a digital image of a planet obtained using a telescope and CMOS camera such as shown in FIGS. 1 and 2.

FIG. 4 is a block diagram illustrating one embodiment of an imaging system that includes a CMOS detector array and an image processor.

FIG. 5 is a block diagram illustrating an embodiment of an imaging system that includes a CMOS detector array and an image processor comprising a computer.

FIG. 6 and FIGS. 7A and 7B are flow charts illustrating preferred methods of processing a plurality of images to yield an improved composite image.

FIG. 8 is the digital image of FIG. 3 as shown by a computer display; the digital image further includes a rectangular boundary demarcating a region of the image for quantitative analysis.

FIG. 9 is a schematic illustration of a two-dimensional array corresponding to locations on the region of the image designated for quantitative analysis.

FIGS. 10 and 11 schematically illustrate two images of an object wherein the object of one image is offset with respect to the same object in the other image.

FIG. 12 schematically illustrates the superposition of a plurality of images to form a composite image.

FIG. 13 is a composite image of the planet depicted in FIG. 3 processed according to a preferred embodiment of the invention.

FIG. 14 is a digital image of the moon obtained using a telescope and CMOS camera.

FIG. 15 is composite image formed by selecting and superimposing a plurality of blurred images such as depicted in FIG. 14.

FIG. 16 is a different image of the moon also obtained using a telescope and CMOS camera.

FIG. 17 is a composite image formed by selecting and superimposing a plurality of images such as depicted in FIG. 16.

FIG. 18 is a different image of the moon also obtained using a telescope and CMOS camera.

FIG. 19 is a composite image formed by selecting and superimposing a plurality of images such as depicted in FIG. 18.

FIGS. 20, 21, and 22 are different views of binoculars having a CMOS camera attached thereto for recording images.

FIG. 23 is a digital image of a terrestrial landscape, a building, obtained using a binoculars having a CMOS camera.

FIG. 24 is a composite image formed by selecting and superimposing a plurality of images such as depicted in FIG. 23.

### DETAILED DESCRIPTION OF THE PREFERRED EMBODIMENT

Various specific embodiments are discussed below for the purpose of illustrating the invention. It will be understood by those skilled in the art that various details discussed below with respect to the practice of a particular embodiment are generally applicable to other embodiments and to the invention in general, unless otherwise stated.

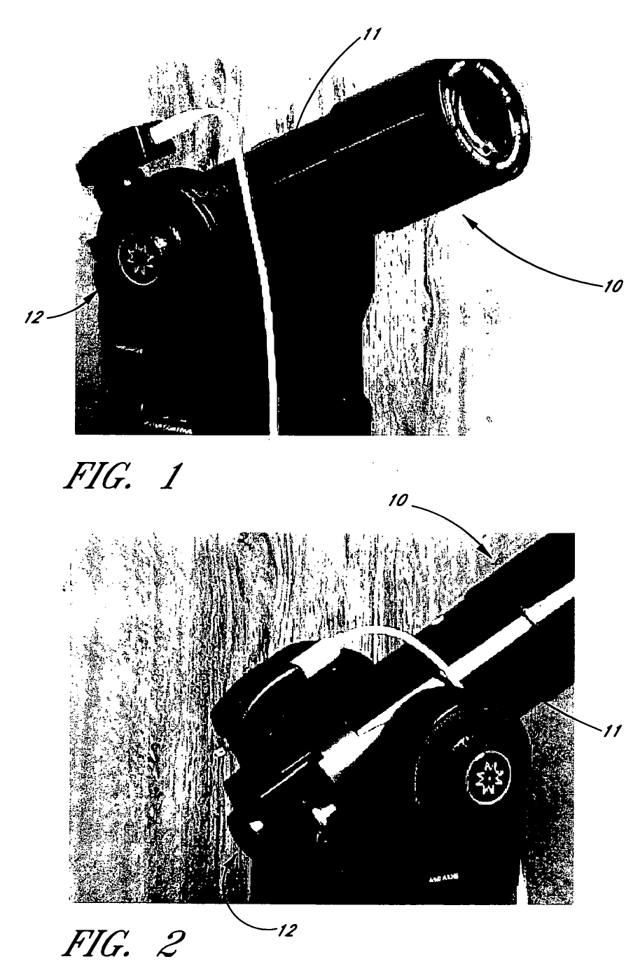

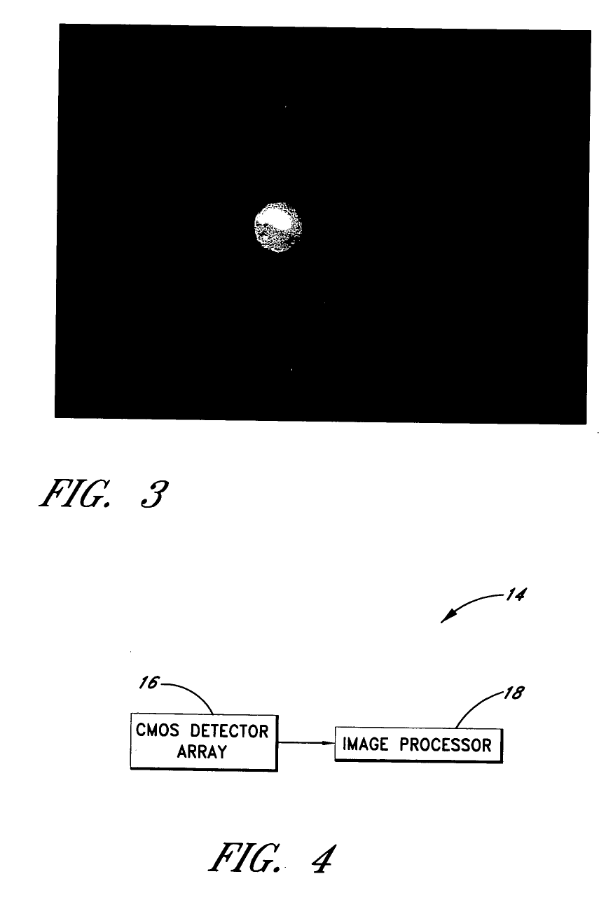

FIGS. 1 and 2 show a telescope 10 comprising telescope optics disposed in a telescope body 11 such as a telescope tube assembly comprising a telescope tube. The telescope optics may comprise a primary and secondary mirror (not shown) as well as possibly other optics such as, for example, a corrector plate in some embodiments. Other optics such as eyepieces may also be included. The telescope 10 should not be limited, however, to any particular design as other configurations may be employed. The telescope 10, for example, may be reflecting, refracting, or catadioptric and may include, for instance, a wide variety of optical and mechanical designs both those well known in the art as well as those yet to be devised.

The telescope 10 may include a camera 12 such as a CMOS camera. The CMOS camera 12 comprises a CMOS detector array preferably disposed at a focal plane or image plane of the telescope 10. The CMOS detector array comprises a two-dimensional array of optoelectronic devices or more specifically, optical detectors that convert optical power into electronic signals. The optical detectors in the two-dimensional array are referred to as pixels. An optical image formed on the image plane of the telescope 10 will be sensed by the CMOS detector array, the various optical detectors each outputting an electrical signal dependent on the amount of light incident on the respective detector pixel. In this manner, an optical image can be recorded as an electronic image. Such images are often referred to as digital images, e.g., in the case where the electronic signals are digitized.

As described above, the optical detectors in CMOS detector arrays are based on CMOS (Complementary Metal Oxide Semiconductor) device technology. Electronics for handling the electrical signals output from the plurality of detectors may be incorporated with the CMOS detector array. Advantageously, CMOS detector arrays are inexpensive and thus preferred. The camera, however, employed in conjunction with the telescope 10 should not be limited to CMOS detectors arrays. Other optoelectronic focal plane arrays such as for example CCD detector arrays may be employed in certain scenarios.

The telescope 10 can be focused on a celestial body such as the moon, planets, stars, comets, brighter deep space objects, or other objects in space or alternatively on a terrestrial object, thereby producing an optical image on the focal or image plane. With the CMOS camera 12, the optical image can be converted into an electronic image. FIG. 3 shows an exemplary electronic image of a planet, Mars, magnified by the telescope 10. The image of Mars is somewhat blurred possibly resulting from atmospheric distortion. As described above, variations in the index of refraction of the atmosphere with time, location, altitude, and temperature, introduce generally unpredictable deviations in the path of light propagating to the telescope. The result is image degradation.

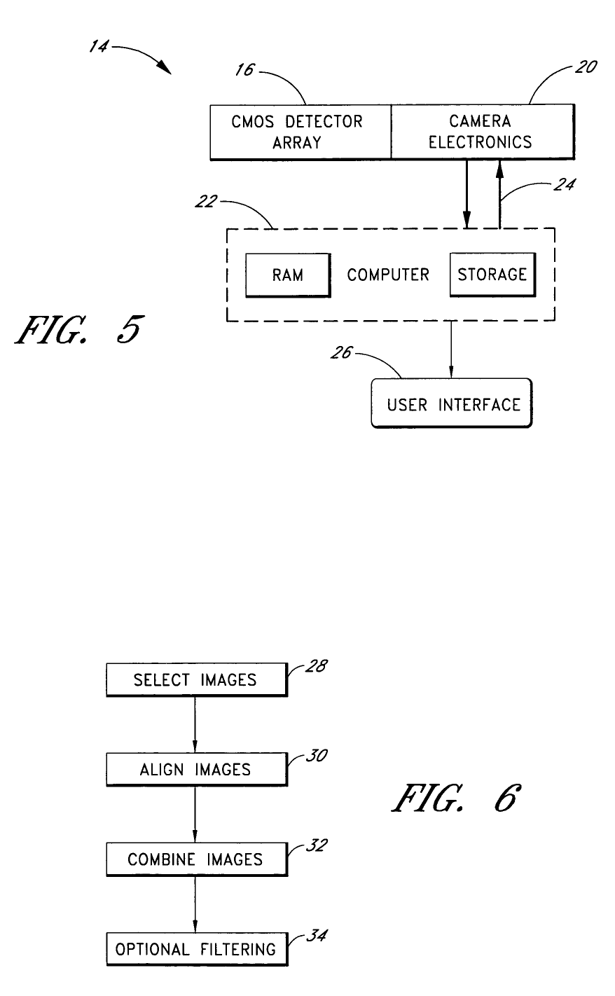

To reduce blurring, optical images are captured by the CMOS focal plane array, and the resultant electronic images are transferred to an image processor. The image processor performs processing that yields an improved image. A block diagram of an imaging system 14 comprising a CMOS detector array 16 and an image processor 18 is depicted in FIG. 4. The image system 14 preferably comprises imaging optics such as a telescope, which is an afocal optical system. Other optical systems, however, may be employed in conjunction with the detector array. For example, the optical system may comprise binoculars as described below. An exemplary image processor 18 may be in the form of analog and/or digital circuits or electronics, one or more microprocessors or computers or any combination thereof. Other structures for implementing processing described herein, both structures well know as well as those yet to be devised, may be employed.

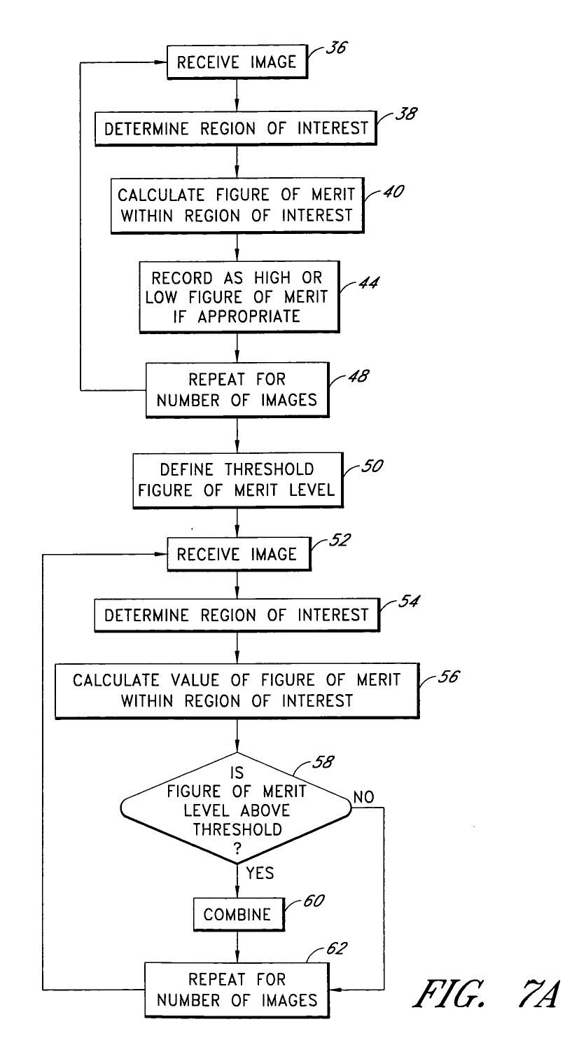

One preferred embodiment of the imaging system 14 is illustrated by the block diagram shown in FIG. 5. Camera electronics 20 may be included with the CMOS detector array 16 as shown. The camera electronics 20 may comprise CMOS circuitry on the same chip as the detector array or may comprise electronics on separate chips, boards, modules, or other electronic structures. In certain embodiments, the camera electronics 20 may digitize, amplify, control, store, or otherwise manipulate the signals output by the detector array 16. The camera electronics 20 preferably facilitate transfer of electrical signals output by the plurality of optical detectors to separate components. Other tasks may be implemented elsewhere in certain embodiments.

The imaging system 14 shown in FIG. 5 further comprises a computer 22. In various preferred embodiments, the optical processing is implemented at least in part by the computer 22. Accordingly, the optical processor 18 depicted in FIG. 4 is preferably embodied at least in part by a computer 22 such as schematically illustrated in FIG. 5. Other processing tasks may be carried out elsewhere and the computer may perform additional functions as well. In alternative embodiments, the optical processor 18 may be implemented by devices other than a computer, however, a computer is preferred. This computer may comprise a microprocessor, a personal computer or work station or other type of computer as well. FIG. 5 shows electrical connection between the camera electronics 20 and the computer 22 provided by a data link 24. This data link 24 may comprise, for example, a USB connection. Other types of connections and formats may be employed. The data transfer should not be limited to electrical or optical links. These connections may be formed for example by wire or cable but also include wireless data transfer.

The computer 22 shown in FIG. 5 includes Random Access Memory (RAM) as well as storage which may comprise, for example, a magnetic or optical hard drive, magnetic or optical disks or other data storage devices. In various preferred embodiments, the image processing is performed at least in large part using RAM and potentially data storage such as a hard drive. The RAM may be employed to temporarily store and process electronic images. The storage devices may also be used to store images as well as possibly program instructions. Various other implementations and configurations, however, can be utilized. The computer 22 shown further includes a user interface 26, which may, for example, comprise a computer display, a keyboard, and/or a mouse. Other user interfaces 26 both those well know as well as those yet to be devised may also be employed.

To reduce blurring, a plurality of images are preferably obtained. In various preferred embodiments, these images are acquired by the detector array 16 onto which somewhat blurred optical images are focused. The detector array 16 captures these blurred images at various points in time and produces electronic representations of the images.

The images may be captured automatically with the assistance of computer or microprocessor control or control electronics and/or control signals or the images may be taken manually. Preferably, multiple exposures are captured using shutter control wherein a shutter is opened to expose the detectors to the optical image. Automatic or manual control of exposure time may be provided. The exposure may range, for example, between about 1/5000 second to 16 seconds. The images can be displayed in real time and a quantitative measure of the quality of the image as well as other measurable characteristics can be provided to the user via the user interface, e.g., display.

Preferably, the multiple electronic images are processed to reduce blurring. FIG. 6 shows a flow chart that illustrates one preferred embodiment of a process for reducing this image degradation. To improve quality such as contrast, a plurality of images are combined to create a composite image that is preferably clearer and less blurred. Preferably, the plurality of images used to create the composite image are selected from a larger set of images, the subset selected being of superior quality.

Selection may be based, for example, on the amount of information contained in the image or the region of the image tested. The information content can be measured, for example, by determining the compressibility of the image or the portion of the image evaluated. The larger the information content, the less compressible the images. Conversely, less information content translates into increased compressibility. Images with larger amounts of information can be chosen. Other images below a threshold level of information content may be excluded from the subset of images combined to produce the higher quality composite image.

Selection may alternatively be based, for example, on the level of image degradation such as blurring or conversely on the level of clarity and contrast. Images with higher contrast, those with more variation in signal magnitude from pixel to pixel, can be chosen. Other images below a threshold contrast level may be excluded from the subset of images combined to produce the higher quality composite image.

Combining the images may comprise summing the magnitudes on a pixel-by-pixel basis. The aggregate magnitude may be scaled in some cases. In various embodiments, for example, the value of a given pixel in the composite image is the average of the magnitudes of the corresponding pixel in each of the images contained in the subset that is used to form the composite.

Prior to combining the images, the images may be translated such that the common features in the image are substantially aligned. Translating the images preferably substantially removes the effects of movement of the features in the image over the period of time during which the plurality of images are obtained. Such movement may result for example from atmospheric disturbances, vibrations of the telescope, or the rotation of the earth. Additional filtering may be employed to improve the quality of the image. This filtering may comprise contrast-enhancing filtering for increasing the contrast. In some embodiments, this filtering may be performed after the images have been combined to form the composite. This filtering is, however, is optional.

FIG. 6 outlines several of these processing steps described above. Block 28 corresponds to selecting a subset of the images from a larger set of images. This selection process preferably improves the quality of the composite image by rejecting images with increased degradation. Block 30 corresponds to aligning the images. In various preferred embodiments, the images are preferably laterally displaced such that features therein are in substantial alignment. Alignment may be excluded in certain embodiments. Block 32 corresponds to combining the images for example by adding the values of the corresponding pixels in each of the selected images together. As indicated above, the sum may be scaled or the aggregate value may otherwise be adjusted. Block 34 corresponds to additional filtering to improve the image quality. Such filtering may comprise, for example, Kernel filtering.

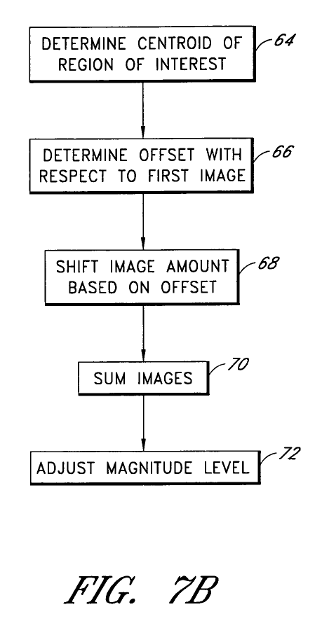

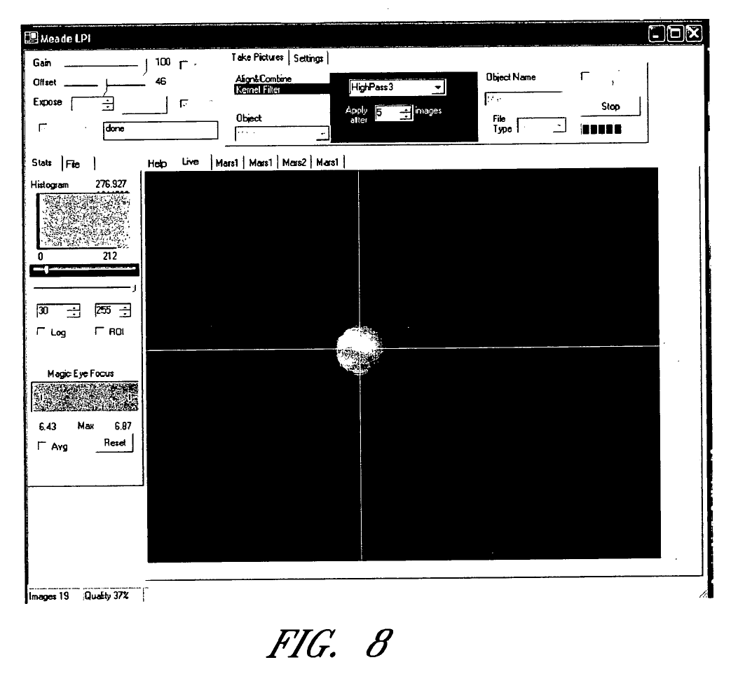

FIGS. 7A and 7B are flow charts illustrating various preferred processes for improving image quality. In such embodiments, an image is received by the optical processor 18 as exemplified by block 36 in FIG. 7A. A portion of the image is selected for sampling the image quality. Performing quantitative analysis over a smaller portion of the image preferably increases processing speed and is therefore advantageous. FIG. 8 shows the region of the image selected for quantitative evaluation. FIG. 8 is a reproduction of the image of FIG. 3, which corresponds to a planet, Mars, in the foreground against the dark background of space. The planet, however, is surrounded by a rectangular boundary that defines the portion of the image selected for analysis. In various preferred embodiments, this region is at least initially selected by the user who may specify the particular region of interest (ROI). Alternatively, the user may select a prominent high contrast feature, such as a bright feature against a dark background or vice versa. Preferably, such a feature has a large amount of detail and information content. The processor 18 may also be configured to select the region of interest, for example, by identifying such a prominent high contrast feature. The size of the region of interest may vary. This step of determining the region for quantitative evaluation is represented block 38 in FIG. 7A.

FIG. 8 depicts the image of the planet as possibly presented to a user via a user interface. This user interface may comprise, for example, a computer screen in the form of a display such as an LCD display or a computer monitor. As described above, the user interface may further comprise a computer keyboard and/or mouse or other computer controls. With the aid of such an interface, the user can specify a particular region for analysis if the processor 18 is not configured to automatically select such a region.

As shown, the screen can also include additional items such as controls for specifying parameters and options associated with the image processing as well as measured values, for example, of information content, blur, contrast, or focus. The screen may also include a histogram showing the distribution pixel intensity in a plot of intensity (x-axis) versus number of pixels (y-axis).

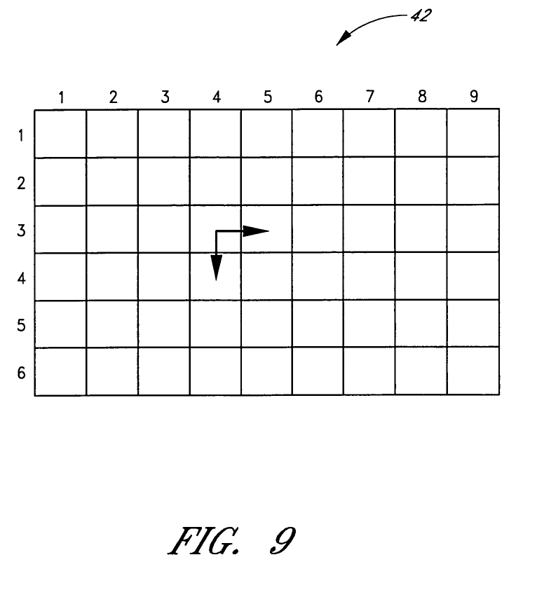

As illustrated by block 40 in FIG. 7A, a figure of merit is calculated for the region selected for quantitative evaluation. FIG. 9 depicts an exemplary array of pixels 42 corresponding to the pixels in the region designated for quantitative analysis. This exemplary array 42 includes six (6) rows and nine (9) columns totaling 54 pixels. The array 42 of FIG. 9, is only used as an example and the number or rows, columns, and total number of pixels may be larger or smaller depending on the region selected. More generally, the region comprises M rows and N column, totaling M×N pixels.

The figure of merit may be based on or related to the quantity of information in the region of interest. Information, information theory, and detail regarding the measurement of information in a message is provided in the seminal paper by C. E. Shannon, “A Mathematical Theory of Communication” The Bell System Technical Journal, Vol. 27, pp. 379-423, 623-656, July, October, 1948, which is incorporated herein by reference in its entirety. The amount of information is one method for assessing the images quality. Images of the same object containing different amounts of information may indicate variation in the quality of the images. For example, an image with degradation such as blurring, low resolution, loss of detail, and/or other affects will generally contain a relatively low amount of information. Such degradation may result, for example, from optical distortion, vibration and movement of the telescope or optical system, electronic noise in the detection apparatus, or from other sources. Conversely, images with large information content may reflect significant resolvable detail. Information content, for example, is also related to the ability to predict from the value of signal in one pixel, the signal in an adjacent pixel. Accordingly, in various preferred embodiments the information content is measured to evaluate the quality of the images such as the resolvable useful detail in the images.

In various embodiments, the information content, how much information in, e.g., the region of interest, is assessed by calculating the compressibility within the designated region 42. The compressibility is indicative of the amount of information contained in the image or designated region 42. For example, a completely dark image such as of the dark sky would have little information and be highly compressible. Conversely, a quality image with extensive detail such as of the surface of the moon would contain large amounts of information and be less compressible. Accordingly, an image file, such as a .TIFF, .JPG, containing an image of the dark sky, if compressed, would be smaller compared to a similar compressed file of the detailed image of the moon. Similarly, optical images of the same object should include the same amount of information, and therefore compress to the same size, unless one of the images is substantially degraded. The degraded image would contain less information than the un-degraded image and could be compressed more. Accordingly, compressibility can be used as a measure of information content, and as described above, the amount of information in like images can be used to assess the quality of the image.

One process for determining the information content comprises adaptive delta modulation. Other approaches, both those well known as well as those yet to be devised may also be employed. Other values besides the compressibility can be used to characterize the information content, and hence the quality of the image in the designated region.

Useful background may be found, e.g., in the Space Telescope Science Institute STSDAS User's Guide, Science Computing and Research Support Division, STSCI, Baltimore 1994, and Barnes, Jeanette, A Beginner's Guide to Using IRAF, IRAF Version 2.10, NOAO, Tucson 1993, which are also each incorporated herein by reference in there entirety. See also, Dantowitz, R.; “Sharper Images Through Video”, Sky and Telescope, Vol.

96., No. 2, p. 48, August 1998, Hale, A. S, Danotwitz, R., Kozubel, M., Teare, S., Gillam, S. G; “The Selective Image Reconstruction (SIR) Imaging Technique: Application to Planetary Science” AAS DPS Meeting #33, Bull of AAS, Vol. 33 p. 1143, and Thompson, L. A. “Adaptive Optics In Astronomy”, Physics Today, Vol. 47, No. 12, pp. 24-31, 1994, which are also each incorporated herein by reference in their entirety.

In various alternative embodiments, the figure of merit used to assess the quality of the images is based on the level of contrast. The level of contrast may be assessed by calculating the variance or standard deviation of signal values among the pixels within the designated region 42. The variance can be computed according to the following equation:
σ²=<I(i,j)²>−<I(i,j)>²
where I(i,j) is the signal level at pixel (i,j), i corresponds to the row and j corresponds to the column for each of the M×N pixels in the array 42. The standard deviation, e.g., the square root of this value, may also be employed. Other values besides the variance and standard deviation can be used to characterize the variation, and hence the contrast level in the designated region.

In another approach for quantifying the level of contrast, the difference in signal intensity between adjacent pixels is determined across the array 42. For example, in one embodiment, the variation can be evaluated by assessing the difference in signal level between a given pixel and the pixel to the right as well as the pixel beneath. For example, for the pixel (3,4) shown in FIG. 9, pixels (3,5) and (4,4) are considered. The signal for these two adjacent pixels is compared to the signal for the pixel (3,4). More generally, for a pixel (i, j), comparison is made with the pixels (i+1,j) and (i,j+1). The value calculated can be based on signal difference between adjacent pixels. Each pixel in the array is preferably considered. A figure of merit based on the sum of these two differences can be used. For example, the first difference δ₁ may be defined as δ₁=|I(i,j)−I(i+1,j)|and the second difference δ₂ may be defined as δ₂=|(i,j)−I(i,j+1)|. The figure of merit can then be defined as

$${\sum }_{i = 0}^{M} {\sum }_{j = 0}^{N} {Δ}_{i , j}$$

where Δ_{i,j}=δ₁+δ₂. Such a summation is preferably computed over the entire array 42 or M×N pixels and yields a figure indicative of the variation among the pixels. A larger value means larger variation and likely higher contrast. Conversely, a smaller value corresponds to smaller variation and lower contrast. This figure of merit can be normalized or scaled. A wide variety of other figures of merit for characterizing the variation and the contrast level can be employed in different embodiments. Moreover, a wide variety of measures of the quality of an image may be utilized.

As indicated by block 44 in FIG. 7A, the figure of merit indicative of the image quality is recorded. Block 44 indicates that the high and the low figure of merit values are recorded. The figure of merit value obtained for the first image analyzed will be both the high and the low threshold level until other images are evaluated to establish a range of levels of the figure of merit.

Another image is received and this portion of the processing represented by blocks 36, 38, 40, and 44 is repeated as exemplified by block 48. Namely, the portion of the image to be quantitatively evaluated is determined, and the figure of merit within that region is measured. For this image, the region for quantitative analysis may remain the same as originally designated by the user or determined by the processor 18. In other embodiments, the location (and potentially the size) of the region may be reevaluated and redefined. The value of the figure of merit for this image is compared with the previously recorded high and low figure of merit values. If this figure of merit value is either higher than the recorded high figure of merit value or lower than the low figure of merit value, this figure of merit value is recorded as the high or low figure of merit value, respectively.

This portion of the processing, represented by blocks 36, 38, 40, and 44 is repeated a number of times. This number may be set by the user via the user interface. In other embodiments, this number may be established by the processor 18. This number may range, for example, between about 5 and 10, however, the number of times that this portion of the processing is repeated may be outside these ranges.

As shown by block 50 in FIG. 7A, a threshold figure of merit value is defined. Preferably, this threshold figure of merit value is based at least in part on the figure of merit values recorded (see block 44) for the plurality of images previously analyzed. In some embodiments, this threshold figure of merit value is based on the information content measured within the region of interest for these images. In some embodiments, this threshold figure of merit value is based on the contrast measured within the region of interest for these images. Still other embodiments are possible.

In various preferred embodiments, upper and lower values such as the maximum and minimum value of the recorded information content or compressibility are identified. The threshold levels may be determined using these values of high and low information content or compressibility. For example, the threshold value may be a value between maximum and minimum recorded information content and/or compressibility, such as half-way between these values or about 50% of the difference between the maximum and minimum. The threshold need not be limited to the midway point. Other levels closer to maximum or closer to minimum may be used instead. In some embodiments the user can specify whether the threshold is about 10% above the minimum, about 20% or 30%, etc., or whatever value he or she desires. Other approaches can be employed to provide a threshold value.

In other preferred embodiments, upper and lower values such as the maximum and minimum value of the recorded variations are identified. In the case where the standard deviation is employed as a measure of contrast, these values may correspond to σₘₐₓ and σₘᵢₙ, respectively. The threshold levels may be determined using these values of high and low variation. As discussed above, for example, the threshold value may be a value between σₘₐₓ and σₘᵢₙ, such as half-way between these values or about 50% of the difference between the maximum and minimum. Other levels closer to maximum or closer to minimum may be used instead. In some embodiments the user can specify whether the threshold is about 10% above the minimum, about 20% or 30%, etc., or whatever value he or she desires. Other approaches can be employed to provide a threshold value.

The threshold determines the quality level of additional images that are used to form the composite image. Accordingly, blocks 52, 54, 56, 58, 60, and 62, represent another portion of the process wherein additional images are received and evaluated. In particular, for each image, the region for quantitative analysis is determined and the figure of merit evaluated within this region is computed. As discussed above, the region for analysis may be the region originally designated by the user or the image processor 18. Alternatively, a new region may possibly be employed. The figure of merit may be assessed by measuring the information content and/or compressibility, contrast and/or variation, as well as other quality indicators within the region of interest, as discussed above.

The figure of merit value of the region is compared with the threshold level as indicated by block 58. If the figure of merit value is larger than the threshold level, the image is added to the composite. If the figure of merit value is less than the threshold level, the image is not added to the composite. Accordingly, if the threshold is high, higher quality images will be added to form the composite. Similarly, if the threshold is low, lesser quality images will be included in forming the composite.

This portion of the process is repeated a number of times as indicated by block 62. The number of times that this process is repeated may depend on the number of images captured, may be specified by the user, or may be determined by the processor 18, or otherwise realized. This number may be, for example, between about 15 to 100, e.g., between about 15 and 30 or between about 50 and 100, or more, however, the number of times that this portion of the process is repeated may be outside these ranges as well. The number of images selected and added to form the composite may, for example, be between about 50 to 100 although a more or less number can be used. In some embodiments, between about 200 to 300 images can be evaluated, although the number may be larger or smaller. To Capturing 200 to 300 images may take 2 to 3 minutes with 1/10 second exposure time.

As indicated above, a wide range of algorithms can be employed as a measure of quality and the specific measurement and/or calculation to assess such image quality need not be limited to those specifically recited herein. Moreover, although in discussing the process shown in FIG. 7A, the information content and contrast level are determined to select the images to be used to form the composite, in other embodiments, different characteristics may be measured or calculated to make such a selection. Preferably, such characteristics are indicative of the quality of the image, such that only higher quality images are added to the composite, although the process should not be so limited.

(Note that the quality evaluation, e.g., information content, contrast, etc., can be employed to offer additional functions to the user. The calculated value of figure of merit such as information content or contrast, for example, can be displayed for images obtained to provide the user with a quantitative measure of the image quality. Such a value can be presented graphically to the user. This feedback may assist the user, for example, in focusing the telescope. The processor can be set to monitor quality as the telescope is adjusted through the focus. Preferably, the display provides the quality level of the current image as well as the highest quantity obtained so that the user could determine the best focus as determined by the value calculated for figure of merit or image quality.)

As discussed above in connection with FIG. 6, the process for improving image quality preferably further comprises aligning features in the images. FIG. 7B shows a flow chart that outlines how alignment can be achieved. In various preferred embodiments, therefore, the summation represented by block 60 in FIG. 7A includes an alignment procedure such as presented in the flow chart of FIG. 7B.

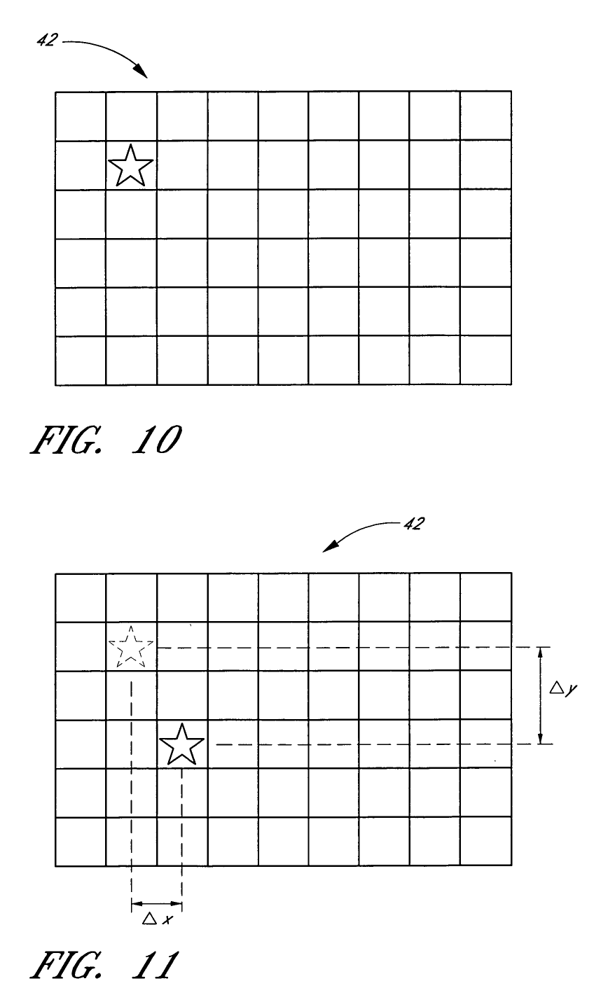

For reasons explained above, the features in one image may be offset with respect to another as schematically illustrated in FIGS. 10 and 11 where the star appears to have moved. To reduce the image degradation introduced by such an offset, the images are preferably translated. To provide the appropriate amount of translation, the offset is preferably determined, for example, by monitoring the movement of one of the features in the designated region. Preferably, a prominent feature that is highly contrasted against the surrounding background is within the designated region. In various embodiments, the region is preferably so designated because of the existence of such a prominent feature.

In the case where the designated region contains such a high contrast feature, the feature may be located by calculating the centroid of the intensity distribution within the designated region. The centroid preferably corresponds to the point in the region in which the intensity within that region may be considered to be concentrated. Accordingly, in the case where the region comprises an image of a bright star, planet, or other celestial object in a dark background, the centroid can be useful in locating a central position of this bright feature in the image. This position can be monitored to track the shift of the feature(s) in image.

Exemplary expressions that may be employed in calculating the X, Y position of the centroid are presented below

$${X}_{centroid} = \frac{{\sum }_{i = 0}^{M} {\sum }_{j = 0}^{N} 1 \times ( I ( i , j ) )}{{\sum }_{i = 0}^{M} {\sum }_{j = 0}^{N} I ( i , j )}$$

$${Y}_{centroid} = \frac{{\sum }_{i = 0}^{M} {\sum }_{j = 0}^{N} j \times ( I ( i , j ) )}{{\sum }_{i = 0}^{M} {\sum }_{j = 0}^{N} I ( i , j )}$$

where I(i,j) is the pixel intensity value at x=i and y=j. Other representations and methods for calculating the centroid are possible.

In various preferred embodiments, the centroid of the designated region is determined as represented by block 64 in FIG. 7B. The movement of the centroid from one image to the next may be calculated for example, from the offset of the centroid with respect to the centroid obtained for the first image. Block 66 is directed to such an approach. The displacement of the centroid from image to image can also be derived by comparing the location of the centroid to other reference points. Other methods of determining the movement of the centroid or other features are also possible

Preferably, the images are shifted an amount, e.g., Δx, Δy, as shown in FIGS. 10 and 11 corresponding to the displacement of the feature being monitored. As described above, in various preferred embodiments, the central location of this feature may be determined in some circumstances by calculating the location of the centroids of the region of interest. In such embodiment, therefore, the images are preferably shifted by an amount corresponding to the offset between the centroids such that the centriods and the prominent feature within the image are aligned. Block 68 indicates that the image is preferably shifted an amount based on this offset.

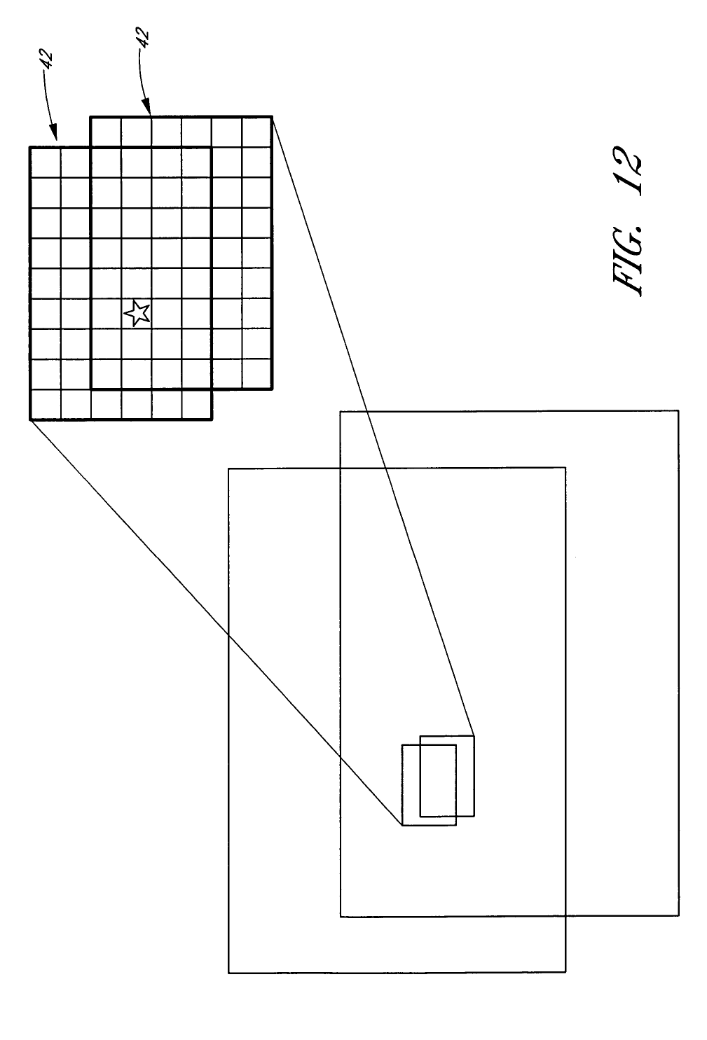

FIG. 12 shows two images shifted by an amount corresponding to the offset measured in the designated regions. Preferably, the result is that the features are substantially aligned. FIG. 12 also shows that the images will partially overlap.

As discussed above, and represented by block 70 in FIG. 7B, the images are summed. Summation may comprise for example adding the magnitude of the values of the overlapping pixels. Other algorithms may also be employed to merge or superimposed the images onto each other. Preferably, proper alignment is provided such that the superimposed images together enhance the contrast of the image rather than introducing additional blur. Moreover, preferably high quality images (e.g., images with high information content, high contrast images, etc.,) are selected and combined to yield an improved image while poorer quality images are excluded from the composite images.

The magnitude levels may be further adjusted, for example, by scaling or normalizing. Other adjustments are also possible. Such adjustments may be represented by block 72.

The composite image may be further processed by filtering. For example, a contrast-enhancing filter may be employed to further improve contrast. As the composite image possesses little noise, contrast-enhancing filtering will increase contrast and highlight features of the object without adding substantial noise. For example, kernel filtering can be employed. As is well known, with Kernel filtering, a convolution kernel is applied to the pixels in the image to obtain new pixel values. See, e.g., Craig A. Lindley, “Practical Image Processing in C”, Wiley Professional Computing, John Wiley & Sons, Inc. 1991, pp. 368-369. Examples of convolution kernels for several high-pass spatial filters are presented below:

$$\begin{matrix}- 1 & - 1 & - 1 \\ - 1 & 9 & - 1 \\ - 1 & - 1 & - 1\end{matrix} \begin{matrix}0 & - 1 & 0 \\ - 1 & 5 & - 1 \\ 0 & - 1 & 0\end{matrix} \begin{matrix}1 & - 2 & 1 \\ - 2 & 5 & - 2 \\ 1 & - 2 & 1\end{matrix}$$

Other types of kernel filters can also be employed. Other filters and filtering techniques other than Kernel filtering may also be used for improving image quality or altering the image as desired.

For example, another technique that can be employed to improve image quality is dark subtraction wherein the fixed pattern noise of the detector is subtracted out of the image. A table or database of fixed pattern detector noise can be created that comprises the fixed pattern noise for a variety of exposure levels for the detector. This database may be generated by capturing a number of images over different time intervals with a closed shutter over the detector array. For a given exposure setting, therefore, the appropriate fixed pattern noise can be obtained from the database by the processor and subtracted out of the electronic image. Fine adjustment can also be performed by scaling the fixed pattern noise that is subtracted out of the image. Such fine tuning may be useful where the database does not include fix pattern noise exactly matching that produced for the exposure time selected. For example, if the database includes fixed pattern noise for 1/600 second and 1/500 second exposure times and the CMOS camera is set for 1/650 second exposure, the fixed pattern noise for 1/500 can be selected and the fixed pattern noise scaled appropriately. Scaling can be employed in other circumstance also to adjust the image.

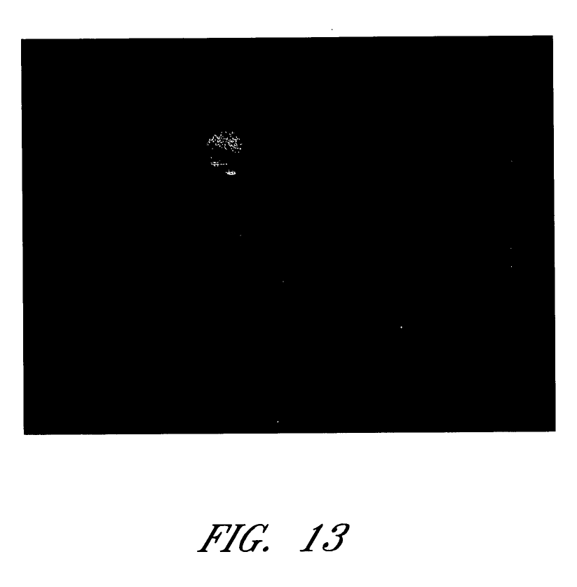

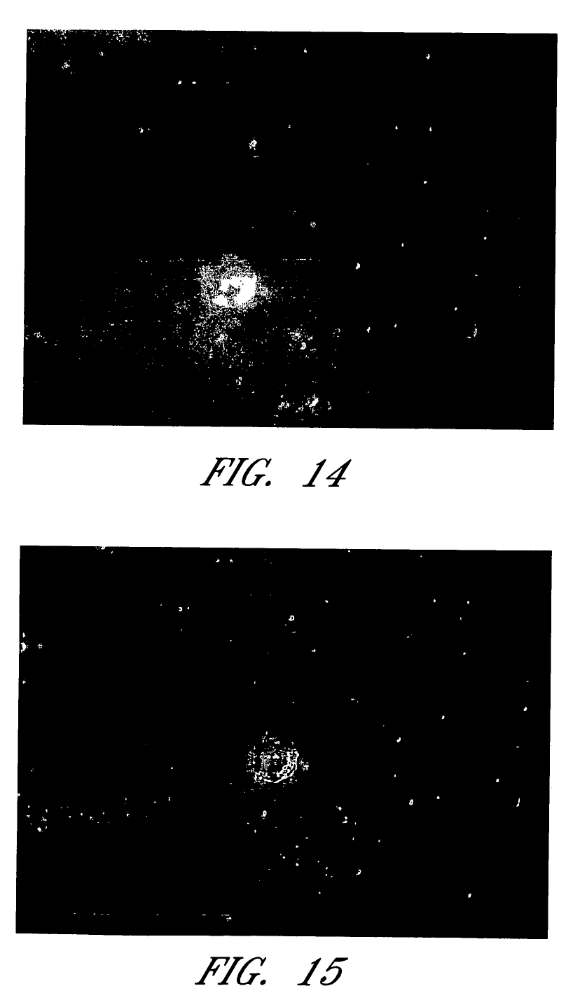

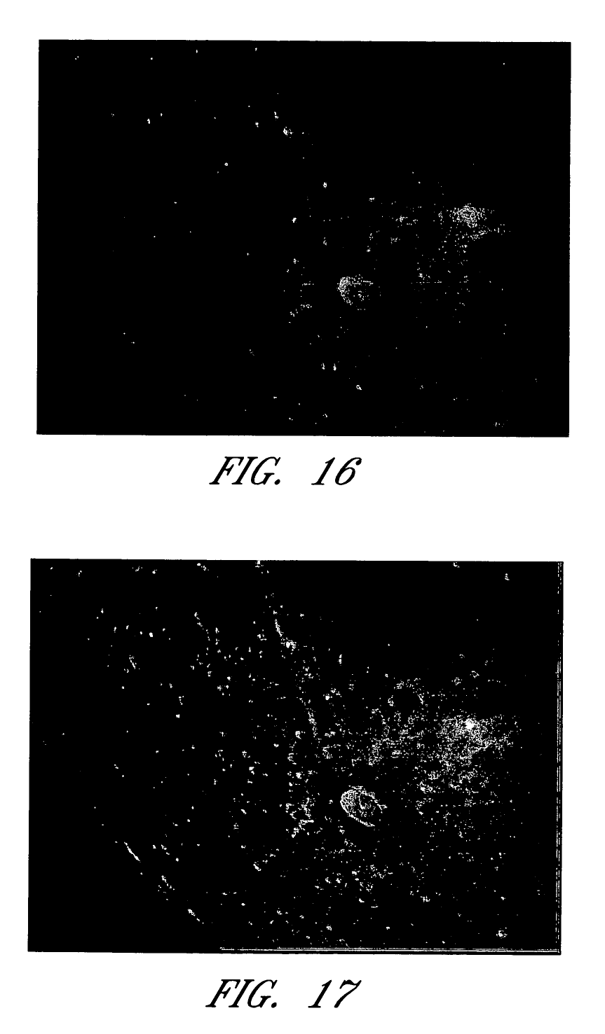

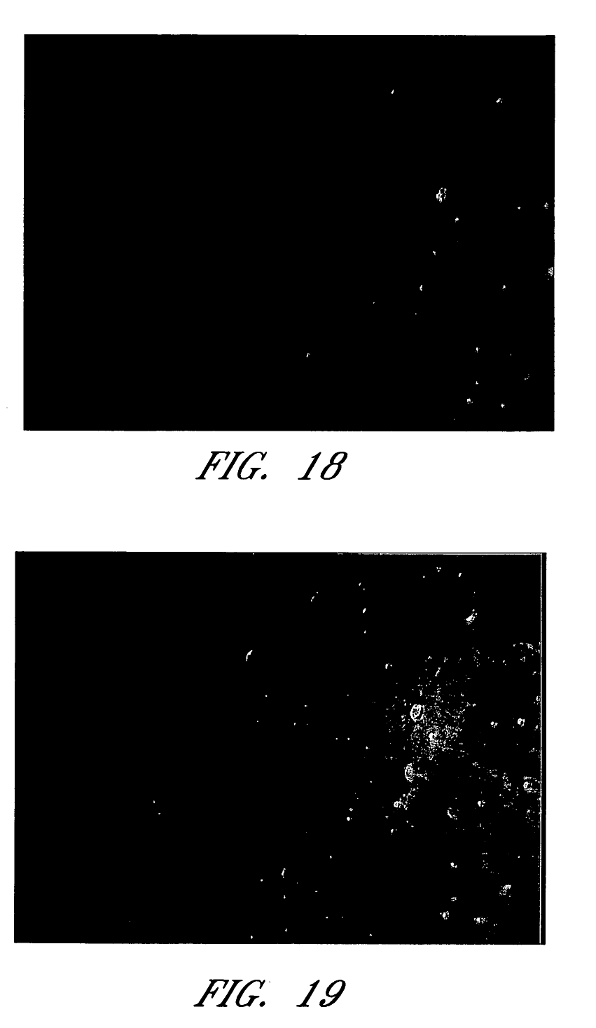

FIG. 13 is a composite image based on images of Mars similar to that shown in FIG. 3. Examples of the successful performance of the image processing described herein are also shown in FIGS. 14-19. FIGS. 14, 16, and 18 correspond to images of the moon having blur. FIGS. 15, 17, and 19 correspond to respective composite images formed using imaging processors and image processing techniques described herein. The composite image in FIG. 15 was formed using a plurality of blurred images similar to that shown in FIG. 14. The composite image in FIG. 17 was formed using a plurality of blurred images similar to that shown in FIG. 16, and the composite image in FIG. 19 was formed using a plurality of blurred images similar to that shown in FIG. 18. The enhanced contrast is readily discernible.

Such improved image quality can be achieved by employing the embodiments discussed above, for example, in connection with FIG. 6, 7A and 7B as well as FIGS. 8-12. Alternative approaches are also possible. The processing steps may be interchanged and may be executed in different order or may be excluded or replaced altogether. Additional processing steps and features can also be added.

Additionally, logic may be executed on the architecture such as shown for example in FIG. 5 in accordance with processes and methods described and shown herein. These methods and processes include, but are not limited to, those depicted in at least some of the blocks in the flow chart of FIG. 6 as well as the schematic representations in FIGS. 9-12 and flow charts in FIGS. 7A and 7B. These and other representations of the methods and processes described herein illustrate the structure of the logic of various embodiments of the present invention which may be embodied in computer program software. Moreover, those skilled in the art will appreciate that the flow charts and description included herein illustrate the structures of logic elements, such as computer program code elements or electronic logic circuits. Manifestly, various embodiments include a machine component that renders the logic elements in a form that instructs a digital processing apparatus (e.g., a computer, controller, processor, laptop, palm top, personal digital assistant, cellphone, kiosk, videogame, or the like, etc.) to perform a sequence of function steps corresponding to those shown. The logic may be embodied by a computer program that is executed by the processor as a series of computer- or control element-executable instructions. These instructions or data usable to generate these instructions may reside, for example, in RAM or on a hard drive or optical drive, or on a disc or the instructions may be stored on magnetic tape, electronic read-only memory, or other appropriate data storage device or computer accessible medium that may or may not be dynamically changed or updated. Accordingly, these methods and processes including, but not limited to, those depicted in at least some of the blocks in the flow chart of FIG. 6 as well as the schematic representations in FIGS. 9-12 and flow charts in FIGS. 7A and 7B may be included, for example, on magnetic discs, optical discs such as compact discs, optical disc drives or other storage device or medium both those well known in the art as well as those yet to be devised. The storage mediums may contain the processing steps which are implemented using hardware to process images such as from telescopes or binoculars, or other optical systems and other images as well. These instructions may be in a format on the storage medium, for example, data compressed, that is subsequently altered.

Additionally, some or all the processing can be performed all on the same device, on one or more other devices that communicates with the device, or various other combinations. The processor may also be incorporated in a network and portions of the process may be performed by separate devices in the network. Display of the images such as the composite image or display of other information, e.g., a user interface, can be included on the device, can communicate with the devices, and/or communicate with a separate device.

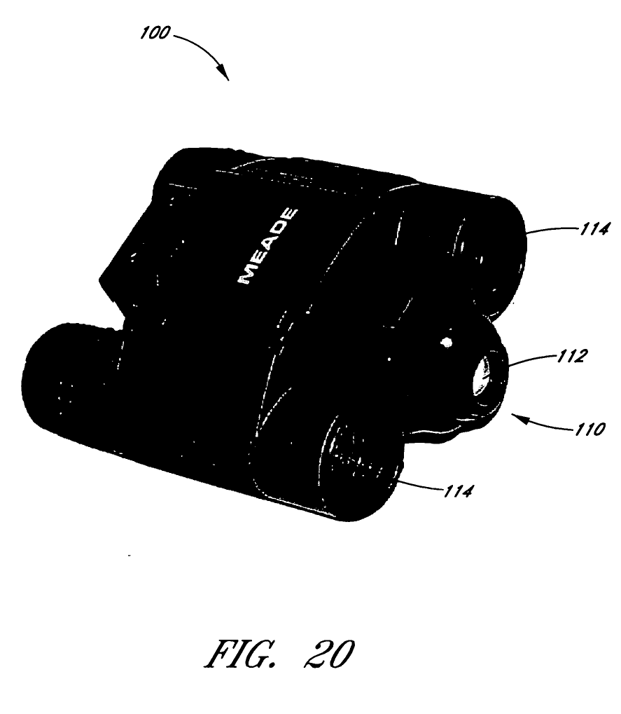

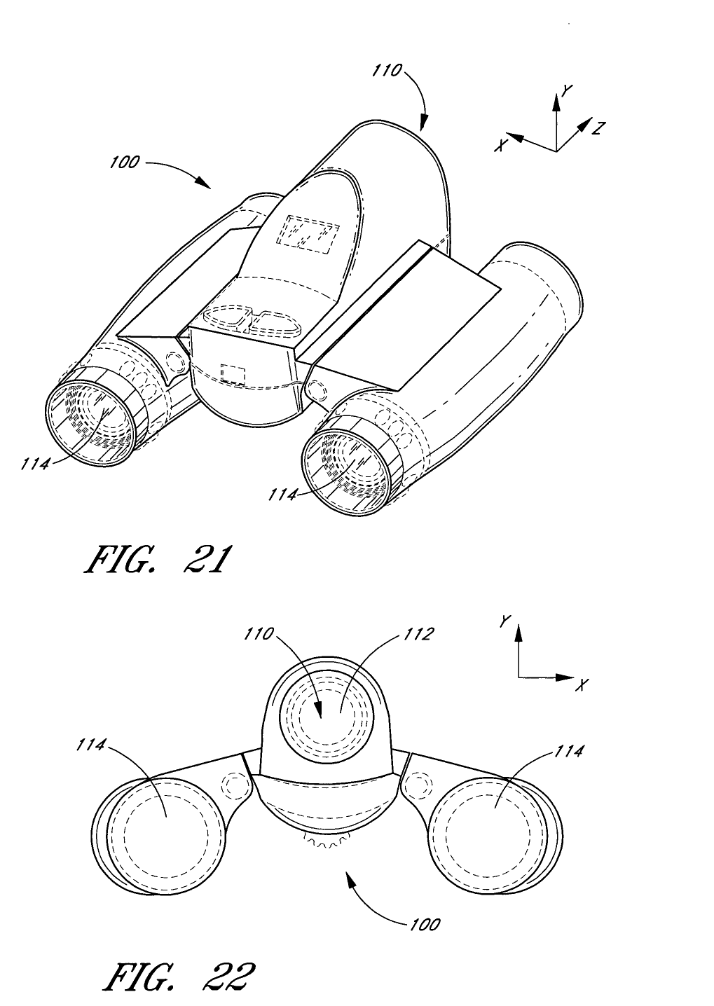

The structures and processes described above are not limited solely to use for astronomical applications. The image processor 18 and processing techniques can be used to reduce image blur for other imaging systems such as, for example, terrestrial telescopes and binoculars having an optoelectronic detector array. FIGS. 20-22 show various embodiments of binoculars 100 equipped with CMOS cameras 110. The binoculars 100 may comprise a pair of afocal optical imaging systems that provide a user with a magnified view, for example, of a terrestrial-based landscape or object. The binoculars 100 shown in FIGS. 20-22 further comprise CMOS cameras 110 for recording a similar image of the terrestrial object being viewed by the user. The magnification of the CMOS camera 110 is preferably about the same as the magnification of the binoculars, e.g., about 7 to 20× magnification, although the magnifications may be outside this range. As discussed above, the CMOS cameras 110 produce an electrical output yielding an electronic image.

In certain preferred embodiments, separate optical systems are employed for the user's eyes and the CMOS camera 110. The optics within the binoculars 100 may comprise a plurality of powered refractive optical elements (e.g., objective and ocular) and prisms for inverting the image. The CMOS camera 110 may also comprise refractive optical elements for forming an optical image on the CMOS detector array. As describe above, other detection devices, such as for example CCDs, may be employed. Other optical designs and configurations are also possible as described above. FIGS. 20 and 22 depict the optical systems 112, 114 for forming images on a CMOS detector array as well as the optical systems that direct optical images into the user's eyes. In other embodiments, however, the CMOS detector array may employ optics also used to form an optical image in the eye.

As discussed above, CMOS detectors arrays are substantially less expensive than CCD detector arrays. CMOS detectors, however, are also less sensitive. Accordingly, in low light conditions, such as for example dusk, indoors, artificial lighting, etc., these CMOS detectors have difficulty capturing high quality images.

Moreover, handheld binoculars suffer from anatomical vibration. The hands naturally have limited ability to hold the binoculars completely steady. As a result, the user holding the binoculars introduces movement into the optical system during the period over which the images are recorded. This movement is generally lateral movement (e.g., in the x and y directions) which is transverse to the optical axis (e.g., z-direction) of the optical systems. Such vibrations and other movements cause the CMOS camera 110 to capture a blurred image.

To reduce blur, the exposure time of the CMOS camera can be shorten such that the image is captured with a reduced amount of movement and vibration. For example, if an aperture is employed to control exposure of the detector array, the shutter can be opened for a shorter period of time during image capture. The images will therefore be under exposed. Shortening the exposure time, however, limits the quantity of light and thus the image will be more faint as less light is collected by the CMOS detector array. As discussed above, however, the CMOS detector array is particularly susceptible to effects of low light levels.

To mitigate against these effects which otherwise degrade the image quality, a plurality of short exposure images is obtained. The exposure length is sufficiently short to reduce the effects of vibration. These exposure times, may for example range between about 1/5000 second to 1/100 second. For example, the exposure time may be between about 1/1000 and 1/100 second or between about 1/5000 and 1/1000 second. Exposure times outside these ranges, however, are possible. The number of images captured is preferably between about 10 to 50, such as between about 10 to 20 or 30 to 50, although more or less images may be obtained. To improve image quality, preferably at least a portion of these images are combined to form a composite image as described above.

Moreover, the plurality of images used to create the composite image are preferably selected from a larger set of images, the subset selected being of superior quality. Selection may be based, for example, on image content and/or compressibility, on the level of image degradation such as blurring or conversely on the level of clarity and contrast. Images with higher information content can be chosen. The compressibility may be used to determine the information content. As described above, images with higher contrast, those with more variation in signal magnitude from pixel to pixel, can also be chosen. Other images below a threshold level may be excluded from the subset of images combined to produce the higher quality composite image. Combining the images may comprise summing the magnitudes on a pixel-by-pixel basis. The aggregate magnitude may be scaled in some cases. In various embodiments, for example, the value of a given pixel in the composite image is the average of the magnitudes of the corresponding pixel in each of the images contained in the subset that is used to form the composite.

Prior to combining the images, the images may be translated such that the common features in the image are substantially aligned. Translating the images preferably substantially removes the effects of movement of the features in the image over the period of time during which the plurality of images are obtained. Such movement may result for example from vibrations. Additional filtering may be employed to improve the quality of the image. This filtering may comprise contrast-enhancing filtering for increasing the contrast. In some embodiments, this filtering may be performed after the images have been combined to form the composite. This filtering is, however, optional.

Preferred embodiments of the structures and configuration of the imaging system are extensively discussed above. Some of the applicable structures include those shown in FIGS. 4 and 5. In one preferred embodiment, for example, the CMOS camera is electrically coupled to a computer via a USB connection as described above. In another preferred embodiment, the binoculars include RAM or other electronics, and image processing is performed in this RAM or other electronics. In such a configuration, the binoculars may also include a display and the processed image can be displayed on this display. The processed image can also be stored on a flash card or transferred to another component such as a computer through a data link such as, e.g., a USB port.

Preferred embodiments of the image processing techniques are also extensively discussed above. Some of these applicable processes are illustrated by FIGS. 6, 7A, 7B, 8, 9, 10, 11, and 12 and the discussions relating thereto. These processes can also advantageously be employed to improve the quality of the images obtained from the CMOS camera in the binoculars as well.

In one preferred embodiment, however, the region designated for quantitative analysis is presumed to be substantially located at the center of the field-of-view. A user is likely to orient the binoculars such that the object of interest is central. Accordingly, the region of interest is centrally located in certain preferred embodiments. Other approaches for determining the location of the region designated for analysis may be employed as well. As discussed above, evaluating the image over a smaller designated regions expedites processing.

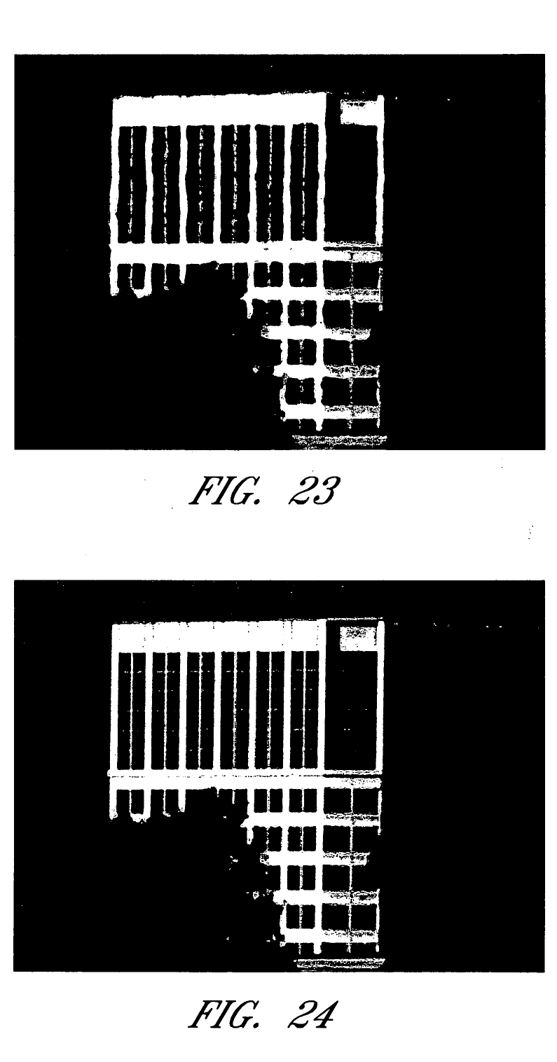

Further examples of the successful performance of the image processing described herein are shown in FIGS. 23 and 24. FIG. 23 is an image of a terrestrial object obtained from a CMOS camera 110 incorporated in a pair of binoculars 100. This image exhibits noticeable blur. FIG. 24 is a composite image formed using an imaging processor and image processing techniques described herein. The composite image in FIG. 24 was formed from a plurality of blurred images similar to that shown in FIG. 23. The improved clarity provided by the image processor is readily discernible.

It will be appreciated by those skilled in the art that various omissions, additions and modifications may be made to the processes described above without departing from the scope of the invention, and all such modifications and changes are intended to fall within the scope of the invention, as defined by the appended claims.

1. A method of processing images from a telescope comprising:
receiving a set of images from said telescope;
assessing the quality of said images by performing a quantitative evaluation of at least a portion of the image;
selecting a subset of said images based on the quality of said images; and
combining said subset of images into a composite image.

2. The method of claim 1, wherein said quality of said images are assessed based on the quantity of information in said images.

3. The method of claim 2, wherein images having increased information content are selected.

4. The method of claim 2, wherein said the quantity of information is assessed by measuring the compressibility of the image.

5. The method of claim 2, wherein said quantity of information is assessed using adaptive delta modulation.

6. The method of claim 1, wherein said the quality of said images is evaluated based on image contrast.

7. The method of claim 1, wherein said quantitative evaluation is performed over a fractional portion of said image thereby increasing processing speed.

8. The method of claim 1, further comprising translating at least a portion of said subset of images such that a common feature in said images are substantially aligned.

9. The method of claim 1, wherein said combining said subset of images comprises summing said images.

10. The method of claim 1, further comprising filtering said composite image.

11. The method of claim 1, wherein a region of interest is selected for performing said quantitative evaluation that includes a prominent high contrast feature.

12. The method of claim 1, further comprising using the quality of the images to identify improved focus settings and indicating to a user which focus setting provides improved focus.

13. A telescope comprising:
a telescope body;
telescope optics for collecting light from a distant object to facilitate optical image formation of said distant object in an optical image plane;
a detector array substantially disposed in said optical image plane, said detector array outputting an electrical signal corresponding to an electronic image comprising a plurality of pixels; and
an image processor receiving a plurality of said electronic images, said image processor configured to evaluate the quality of said electronic images, to select a subset of said electronic images based on the quality of said electronic images, and to combine said subset of electronic images into a composite image.

14. The telescope of claim 13, wherein said telescope body comprises a telescope tube.

15. The telescope of claim 13, wherein said image processor is configured to quantify the information content in said images to evaluate the quality of said images.

16. The telescope of claim 13, wherein said image processor is configured to calculate a figure of merit characterizing the predictability of a signal for a second pixel based on a signal for a first pixel.

17. The telescope of claim 16, wherein said first and second pixels are adjacent.

18. The telescope of claim 13, wherein said image processor is configured to calculate a figure of merit based on variation in signal values among pixels in a region of interest in said electronic images.

19. The telescope of claim 13, wherein said telescope optics has variable focus settings and said image processor accesses memory for recording which focus setting yields increased image quality.

20. A computer program capable of accepting an input representing an image obtained from a telescope imaging system, said computer program configured to assess the quality of an images based on a measure of the amount of information content in at least a portion of the image, to select images based on the amount of information content measured, and to combine said selected images into a composite image.

21. The computer program of claim 20, wherein the computer program is configured to determine a threshold level of information content from measurements on a first set of images and select images by comparing the information content in a second set of images to said threshold level of image content.

22. The computer program of claim 21 wherein said first set of images used to determine said threshold level is between about 5 to 10 images.

23. The computer program of claim 22, wherein the second set of images comprises about 15 and 100 images.

24. The computer program of claim 21, wherein the number of images selected comprises between about 50 to 100.

25. An article of manufacture comprising an image processing module for a telescope stored in a computer accessible storage media and executable in a processor, the image processing module configured to measure compressibility of images from said telescope, to select a subset of said images from said telescope based on said compressiblity, and to combine said subset of images from said telescope into a composite image.

26. The article of manufacture of claim 25, wherein said image processing module is configured to translate at least a portion of said subset of images from said telescope such that a common feature in said images are substantially aligned.

27. An optical system comprising:
means for receiving a set of images; and
means for evaluating the quality of said images by performing a quantitative evaluation of at least a portion of the image, selecting a subset of said images based on said quality of said images, and combining said subset of images into a composite image.

28. Binoculars comprising:
left and right optical paths each comprising an objective and an ocular;
an electronic camera comprising an optoelectronic detector array outputting an electronic signal; and
image processing electronics for processing electronic images generated from said optoelectronic detector array, said imaging processing electronics configured to combine a plurality of said electronic images into a composite image.

29. The binoculars of claim 28, wherein said image processing electronics is further configured to evaluate the quality of said electronic images by performing a quantitative evaluation of at least a portion of the electronic image and selecting said plurality of said electronic images for said composite image based on said quality of said images.

30. The binoculars of claim 29, wherein said quantitative evaluation comprises quantifying the amount of information in said electronic image.

31. The binoculars of claim 30, wherein said quantitative evaluation comprises measuring compressibility of said electronic image.

32. The binoculars of claim 29, wherein said quantitative evaluation comprises assessing image contrast.

33. The binoculars of claim 32, wherein said quantitative evaluation comprises measuring variation in signal in said electronic image.

34. The binoculars of claim 29, wherein said quantitative evaluation is performed over a fractional portion of said electronic image thereby increasing processing speed.

35. The binoculars of claim 29, further comprising translating at least a portion of said plurality of electronic images such that a common feature in said electronic images is substantially aligned.

36. The binoculars of claim 29, further comprising filtering to increase clarity in said composite image.

37. The binoculars of claim 29, wherein said processing electronics is configured to select a region of interest as said at least a portion of said electronic image for performing said quantitative evaluation that includes a prominent high contrast feature.

38. The binoculars of claim 29, further wherein said processing electronics is configured to use the quality of the electronic images to identify improved focus settings and indicate to a user which focus setting provides improved focus.

39. An optical imaging apparatus comprising:
binoculars;
an electronic camera comprising an optoelectronic detector array outputting an electronic signal; and
image processing electronics for processing electronic images generated from said optoelectronic detector array, said imaging processing electronics configured to combine a plurality of said electronic images into a composite image.

40. The optical imaging apparatus of claim 39, wherein said image processing electronics is configured to calculate a value of a figure of merit based on the compressibility of said region of interest of said electronic images and to use said value of figure of merit to select said plurality of electronic images for said composite image.

41. The optical imaging apparatus of claim 39, wherein said image processing electronics is configured to calculate a value of a figure of merit based on variation in signal in a region of interest in said electronic images and to use said value of figure of merit to select said plurality of electronic images for said composite image.

42. The optical imaging apparatus of claim 39, wherein said binoculars has variable focus settings and said image processor accesses memory for recording which focus setting yields increase image quality.

43. An optical imaging system comprising:
a telescope assembly including telescope optics;
an electronic camera disposed with respect to said telescope assembly to receive light from said telescope optics for image formation and recording, said electronic camera comprising an optoelectronic detector array outputting an electronic signal; and
image processing electronics for processing electronic images generated from said optoelectronic detector array, said imaging processing electronics configured to combine a plurality of said electronic images into a composite image.
